(19) United States
(12) Patent Application Publication
(10) Pub. No.: US 2017/0363030 A1
(43) Pub. Date: Dec. 21, 2017

(54) METHOD OF IDENTIFYING A FAULTED COMPONENT IN AN AUTOMOTIVE SYSTEM

(71) Applicant: GM GLOBAL TECHNOLOGY OPERATIONS LLC, Detroit, MI (US)

(72) Inventors: Massimiliano MELIS, Rivoli (IT); Filippo PARISI, Torino (IT); Eugenio MANTA, Torino (IT); Nicola COSTA, Beinasco (IT); Michele BELLUSCIO, Villanova d'Asti (IT)

(73) Assignee: GM GLOBAL TECHNOLOGY OPERATIONS LLC, Detroit, MI (US)

(21) Appl. No.: 15/626,657

(22) Filed: Jun. 19, 2017

(30) Foreign Application Priority Data
Jun. 17, 2016 (GB) 1610617.1

(51) Int. Cl. F02D 41/22; F02D 41/26; F02D 35/02

(52) U.S. Cl. CPC F02D 41/22; F02D 35/027; F02D 41/26

(57) ABSTRACT

A method of identifying a faulted component in an automotive system including an internal combustion engine managed by an Electronic Control Unit. The internal combustion engine is operated according to a predefined detection routine. A noise signal emitted by the activated internal combustion engine is recorded in a data carrier or memory system. The recorded noise signal is analyzed by a signal treatment algorithm to determine a plurality of vibration modes of the automotive system from the noise signal.; The amplitude of the noise signal is compared at each vibration mode with an acceptable amplitude threshold. A faulted component of the automotive system is determined if the amplitude of the correspondent vibration mode is greater than the acceptable amplitude threshold.

### CROSS-REFERENCE TO RELATED APPLICATION

This application claims priority to Great Britain Patent Application No. 1610617.1, filed Jun. 17, 2016 which is incorporated herein by reference in its entirety.

### TECHNICAL FIELD

The present disclosure pertains to a method of identifying a faulted component in an automotive system.

### BACKGROUND

Automotive systems include several interconnected devices such as an internal combustion engine, a turbocharged system, an Exhaust Gas Recirculation (EGR) system, an aftertreatment system and several other components such as conduits, valves, sensors, fuel injectors and so on.

Due to the complexity of current automotive systems, it is not always easy and straightforward to determine the particular component that is not functioning properly, in case of a fault.

Some faults may be determined by receiving data from the sensors of the automotive system and comparing such data with predefined thresholds or ranges and reporting a fault code if the measured data do not comply with such predefined thresholds or ranges. Nevertheless, a variety of faults may not be easily detected using on-board sensors.

Furthermore, currently a high number of No Trouble Found (NTF) events are caused by replacement of good components in service because robust tools to understand the cause of the automotive system noise are not available. For example, it happens frequently that turbochargers are substituted in case of a certain noise is produced when, in reality, the failed part is a scissor gear associated to a camshaft.

In general, current service procedures are based on the experience of the service personnel but may not always effective.

Accordingly, there is a need to provide a method to detect and distinguish between different faulted components such as engine, turbocharger, balancer wheels, injectors and so on.

### SUMMARY

An embodiment of the disclosure provides a method of identifying a faulted component in an automotive system including an internal combustion engine managed by an Electronic Control Unit, the method includes operating the internal combustion engine according to a predefined detection routine. A noise signal emitted by the activated internal combustion engine is recorded in a data carrier or storage medium. The recorded noise signal is analyzed by a signal treatment algorithm to determine a plurality of vibration modes of the automotive system from the noise signal. The amplitude of the noise signal at each vibration mode is compared with an acceptable amplitude threshold. A faulted component of the automotive system is identified when the amplitude of the correspondent vibration mode is greater than the acceptable amplitude threshold.

It is noted that with “detection routine” a predefined operating mode of the internal combustion engine is meant. Typically, a detection routine is defined by predetermined values of one or more engine operating parameters (e.g. engine speed) in a predetermined time interval. In other words, the engine is operated in a predetermined manner for a predetermined time interval.

An advantage of this embodiment is that it allows to reduce the number of No Trouble Found (NTF) events. Another advantage is that it allows to improve customer satisfaction when diagnosing and repairing a vehicle.

According to another embodiment, the predefined internal combustion engine detection routine includes ramping up an engine speed for a predefined amount of time. An advantage of this embodiment is that it allows the automotive system to vibrate at frequencies that span from a minimum frequency to a maximum frequency to identify a wide number of vibration modes.

According to another embodiment, the predefined internal combustion engine detection routine includes ramping up the engine speed from 1000 rpm to 4000 rpm in 120 seconds. An advantage of this embodiment is to adapt the detection routine to internal combustion engines.

According to a further embodiment, the signal treatment algorithm is a Fast Fourier Transform (FFT). An advantage of this embodiment is that it converts the noise signal from its original time domain to a representation in the frequency domain.

According to still another embodiment, each vibration mode is compared with a correspondent pre-determined acceptable amplitude threshold.

According to a further embodiment, an acoustic sensor or microphone is used to record the noise signal emitted by the automotive system. An advantage of this embodiment is that it allows the use of a microphone generally present in the infotainment system of the vehicle or of an external microphone.

The present disclosure further includes an apparatus for the identification of a faulted component in an automotive system including an internal combustion engine managed by an Electronic Control Unit. The apparatus is configured to operate the internal combustion engine according to a predefined detection routine; record a noise signal emitted by the activated internal combustion engine in a data carrier or storage medium; analyze the recorded noise signal according to a signal treatment algorithm in order to determine a plurality of vibration modes of the automotive system from the noise signal; compare the amplitude of the noise signal at each vibration mode with an acceptable amplitude threshold; and identify a faulted component of the automotive system if the amplitude of the correspondent vibration mode is greater than the acceptable amplitude threshold.

The advantages of this embodiment are substantially the same as those described in reference to the method.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a cross-section of an internal combustion engine belonging to the automotive system of FIG. 1;

FIG. 3 shows an apparatus for carrying out the method of the various embodiments of the present disclosure; and

FIG. 4 shows a block diagram of an embodiment of the method herein disclosed.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

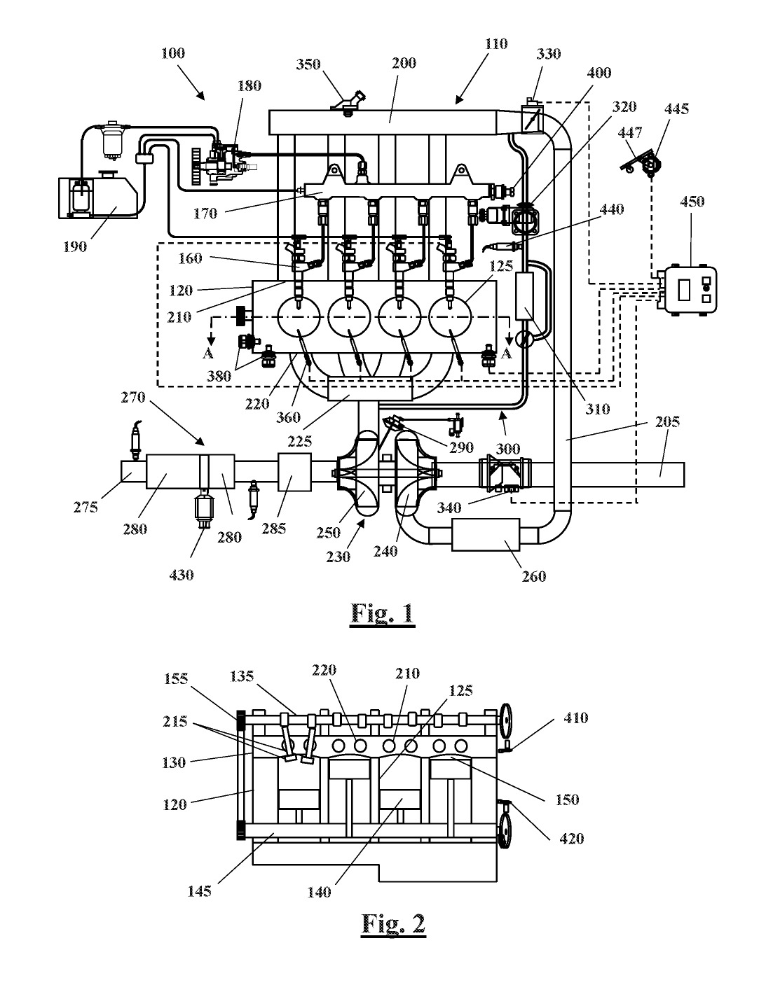

Some embodiments may include a turbocharged automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high-pressure fuel pump 180 that increases the pressure of the fuel received from a fuel source 190. Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an aftertreatment system 600. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The aftertreatment system may include an exhaust line 275 having one or more exhaust aftertreatment devices. The aftertreatment devices may be any device configured to change the composition of the exhaust gases. Some examples of aftertreatment devices include, but are not limited to, catalytic converters (two and three way), oxidation catalysts, lean NOₓ traps, hydrocarbon adsorbers, selective catalytic reduction (SCR) systems, and particulate filters, such as a Diesel Particulate Filter (DPF).

In particular, the aftertreatment system may include a Diesel Oxidation Catalyst (DOC) 285 upstream of a SCRF (Selective Catalytic Reduction SCR on Filter) 280.

In alternative with respect to the SCRF 280, a lean NOₓ trap LNT (not represented for simplicity) may be provided in the aftertreatment system.

Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, an air mass-flow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the VGT actuator 290, and a cam phaser. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier 460, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carry out the steps of such methods and control the ICE 110.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, the carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulation technique such as QPSK for digital data, such that binary data representing the computer program code is impressed on the transitory electromagnetic signal. Such signals are e.g. made use of when transmitting computer program code in a wireless fashion via a Wi-Fi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an on-board computer, or any processing module that might be deployed in the vehicle.

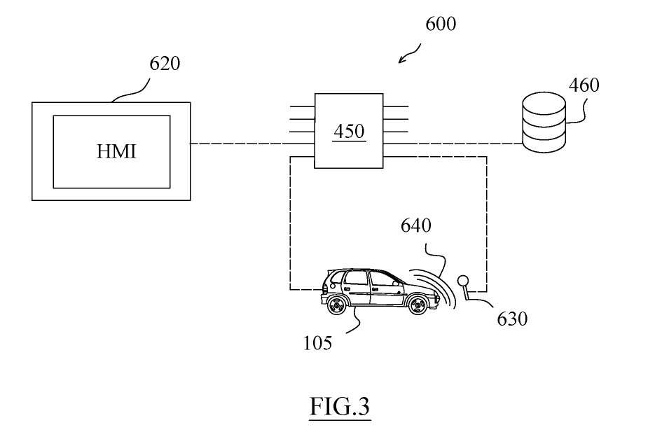

The automotive system may further include an apparatus 600 for the identification of faulted components 700, as depicted in FIG. 3.

The apparatus 600 includes a visual interface 610 associated with a software 620. For example, the software 620 may be embedded in the infotainment of the vehicle as a human to machine interface (HMI).

The apparatus 600 may also include an acoustic sensor 630 configured to acquire a noise signal 640 produced by the operations of the automotive system 100, for example a microphone. The acoustic sensor 630 may be internal or external with respect to a vehicle 105 powered by the automotive system 100.

The software 620 may be used to enable the activation of the internal combustion engine 110 according to a predefined detection routine 680. The recorded noise signal 640 of the automotive system 100 may be stored in the recording data carrier 460 associated to the ECU 450. Furthermore, a pre-determined acceptable signal amplitude threshold 670 may also be stored in the recording data carrier 460 associated to the ECU 450.

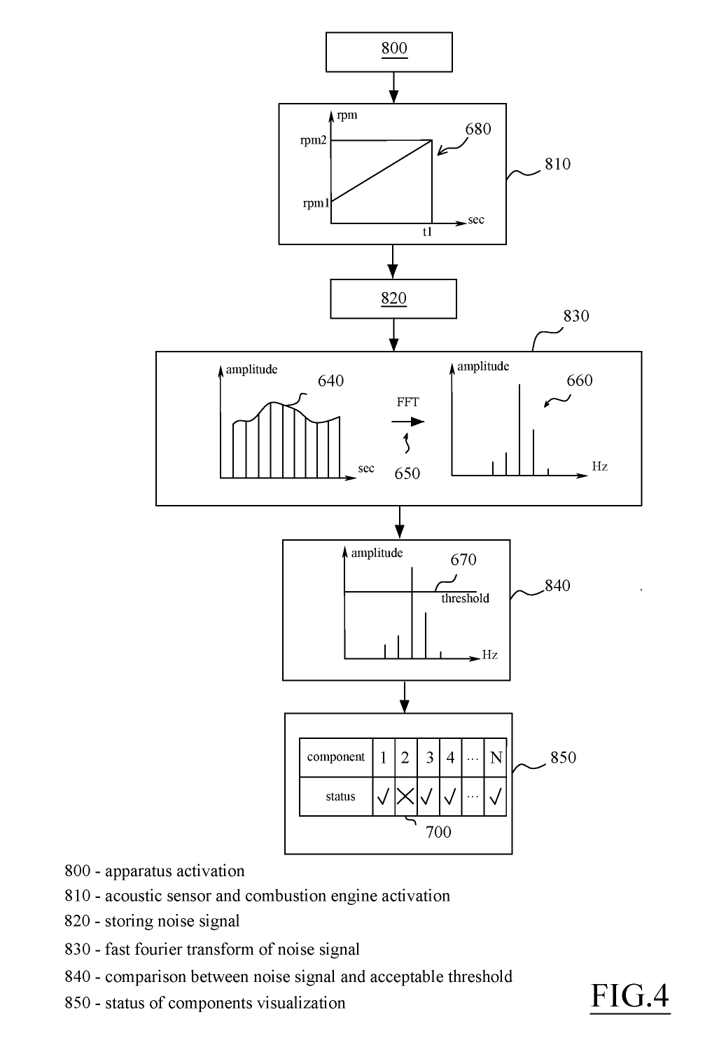

FIG. 4 shows a block diagram of an embodiment of the method herein disclosed. The method of identification of a faulted component starts with the activation of the software 620 of the apparatus 600 by the visual interface 610. The activation may be performed by service personnel (Block 800).

The software is programmed in such a way that, once activated, it enables the activation of the internal combustion engine 110 according to the predefined detection routine. Furthermore, the acoustic sensor 630 is activated. The acoustic sensor 630 records the noise signal 640 emitted by the automotive system 100 as activated with the predefined detection routine.

In a preferred embodiment of the present disclosure the acoustic sensor 630 may be a microphone and the predefined detection routine 680 may consists in ramping up the engine speed from 1000 rpm to 4000 rpm in 120 seconds (Block 810). Other detection routines are possible.

The noise signal 640 produced by the activated automotive system 100 may be stored in the data carrier 460 (Block 820) and is analyzed by the ECU 450 according to a signal treatment algorithm 650 to determine a plurality of vibration modes 660. In a preferred embodiment of the present disclosure the signal treatment algorithm 650 may be a Fast Fourier Transform (FFT) that enables to translate the time domain noise signal 640 emitted by the automotive system 100 in a frequency domain signal to determine the vibration modes 660 (Block 830).

Before analyzing the noise signal 640 emitted by the automotive system 100 with the signal treatment algorithm 650, filtrating operations may be performed to purify the noise signal emitted by the automotive system 100 from the environment noise.

As stated above, a pre-determined acceptable amplitude threshold 670 may be also stored in the data carrier 460.

The signal treatment algorithm 650 not only recognizes in the noise emitted by the automotive system 100 as a plurality of vibration modes 660, but is also able to compare each vibration mode with the pre-determined acceptable amplitude threshold 670 to identify a faulted component 700 of the automotive system 100 if the correspondent vibration mode is greater than the acceptable amplitude threshold 670 (Block 840). The comparison between the noise signal emitted by the automotive system 100 and the acceptable amplitude threshold 670 is performed in the frequency domain.

As can be clearly seen in the spectrum reported in Block 840, every vibration mode coming from the FFT of the noise signal emitted by the automotive system 100 is compared with the pre-determined acceptable amplitude threshold 670. Whenever the amplitude of a particular vibration mode exceeds the amplitude of the threshold 670, the software 620 indicates the component related to that particular vibration mode as faulted.

On the contrary, when the amplitude of a particular vibration mode is lower than the amplitude of threshold 670 the software 620 indicates the component related to that particular vibration mode as not faulted.

It is to be noted that each vibration mode coming from the FFT can be related to a specific component of the combustion engine 110 or to a specific fault of a component of the automotive system 100. In such a way, each vibration mode enables the unique recognition of the faulted component 700.

Once the diagnostic method is completed, an array showing components status of the combustion engine 110 is displayed on the visual interface 610 (Block 850).

In another embodiment of the present disclosure the visual interface 610 and the related software 620 may be embedded as an application in an electronic mobile module, so as to enable the user of the vehicle to perform the method above described without the necessity of specialized personnel. According to this embodiment of the present disclosure the software may be downloaded on the electronic mobile module as a dedicated application.

In still another embodiment of the present disclosure the acceptable amplitude threshold 670 may be determined by the ECU 450 once the FFT is performed and the noise signal emitted by the automotive system 100 is translated into the frequency domain. In particular, the amplitude threshold 670 may be determined averaging the vibration modes in the neighborhood of the vibration mode of interest.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-12. (canceled)

13. A method of identifying a faulted component in an automotive system, the automotive system comprising an internal combustion engine managed by an Electronic Control Unit, the method comprising:
operating the internal combustion engine according to a predefined detection routine;
recording a noise signal emitted by the activated internal combustion engine in a memory system;
analyzing the recorded noise signal with a signal treatment algorithm to determine a plurality of vibration modes of the automotive system from the noise signal;
comparing the amplitude of the noise signal at each vibration mode with an acceptable amplitude threshold; and
identifying a faulted component of the automotive system if the amplitude of the correspondent vibration mode is greater than the acceptable amplitude threshold.

14. The method according to claim 13, wherein the predefined internal combustion engine detection routine comprises ramping up an engine speed for a predefined amount of time.

15. The method according to claim 13, wherein the predefined internal combustion engine detection routine comprises ramping up an engine speed over a predefined range of revolutions per minute for a predefined amount of time.

16. The method according to claim 15, wherein the predefined internal combustion engine detection routine comprises ramping up the engine speed from 1000 rpm to 4000 rpm in 120 seconds.

17. The method according to claim 13, wherein the signal treatment algorithm comprises converting the noise signal from a time domain to a frequency domain.

18. The method according to claim 17, wherein the signal treatment algorithm comprises a Fast Fourier Transformation.

19. The method according to claim 13, wherein recording the noise signal emitted by the automotive system is performed with an acoustic sensor.

20. The method according to claim 13, wherein the identifying step comprises using a relation of vibration modes to a specific component of the combustion engine or to a specific fault of a component of the automotive system to identify the faulted component.

21. A method of identifying a faulted component in an automotive system, the automotive system comprising an internal combustion engine managed by an Electronic Control Unit, the method comprising:
operating the internal combustion engine according to a predefined detection routine which includes ramping up an engine speed over a predefined range of revolutions per minute for a predefined amount of time;
recording a noise signal emitted by the activated internal combustion engine in a memory system with an acoustic sensor;
analyzing the recorded noise signal using a Fast Fourier Transformation to convert the noise signal from a time domain to a frequency domain for determining a plurality of vibration modes of the automotive system from the noise signal;
comparing the amplitude of the noise signal at each vibration mode with an acceptable amplitude threshold;
using a relation of vibration modes to a fault condition of the automotive system for identifying the faulted component; and
identifying a faulted component of the automotive system if the amplitude of the relation of vibration mode is greater than the acceptable amplitude threshold.

22. An apparatus for the identification of a faulted component in an automotive system having an internal combustion engine managed by an Electronic Control Unit, the apparatus including a processor and a non-transitory computer readable medium having a computer code, which when executed on the processor, is configured to:
operate the internal combustion engine according to a predefined detection routine;
recording a noise signal emitted by the activated internal combustion engine in a memory system;
analyze the recorded noise signal according to a signal treatment algorithm to determine a plurality of vibration modes of the automotive system from the noise signal;
compare the amplitude of the noise signal at each vibration mode with an acceptable amplitude threshold; and
identify a faulted component of the automotive system if the amplitude of the correspondent vibration mode is greater than the acceptable amplitude threshold.

23. The apparatus according to claim 22, wherein the Electronic Control Unit comprises the processor executing the computer code.
